(19) United States
(12) Patent Application Publication
(10) Pub. No.: US 2008/0099463 A1
(43) Pub. Date: May 1, 2008

(54) METHOD AND PROCESSING SYSTEM FOR RAPID HOTPLATE COOL DOWN

(75) Inventor: Nicholas Alan Ryza, Austin, TX (US)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 11/537,096

(22) Filed: Sep. 29, 2006

(51) Int. Cl. H05B 3/68

(52) U.S. Cl. 219/448.11

(57) ABSTRACT

A method and processing system for controlling and rapidly lowering the temperature of a hotplate used for supporting and heat-treating wafers. The method includes maintaining the hotplate at a first hotplate temperature by applying a first heating power to the hotplate and heat-treating a wafer on an upper surface of the hotplate, removing the heat-treated wafer from the upper surface, exposing the upper surface to an inert gas stream for rapid cool down of the hotplate from the first hotplate temperature to a second hotplate temperature, and maintaining the hotplate at the second hotplate temperature by applying a second heating power to the hotplate and heat-treating another wafer on the upper surface of the hotplate.

### FIELD OF THE INVENTION

The invention relates to wafer processing, and more particularly, to a method and processing system for controlling and rapidly adjusting the temperature of a hotplate used for supporting and heat-treating wafers.

### BACKGROUND OF THE INVENTION

In a photolithography process for manufacturing semiconductor devices and liquid crystal displays (LCD's), resist is coated on a substrate, and the resultant photoresist coating film is exposed to light and developed. The series of processing stages are carried out in a coating/developing processing system having discrete heating sections, such as a prebaking unit and a postbaking unit. Each heating section incorporates a hotplate with a built-in heater.

Feature sizes of semiconductor device circuits have been reduced to less than 0.1 microns. Typically, the pattern wiring that interconnects individual device circuits is formed with sub-micron line widths. To provide reproducible and accurate feature sizes and line widths, it has been strongly desired to control more accurately light exposure parameters and the heat treatment temperature of the photoresist film. The substrates or wafers (i.e., objects to be treated) are usually treated or processed under the same recipe (i.e., individual treatment program) in units (i.e., lots) each consisting of, for example, twenty-five wafers. Individual recipes define heat treatment conditions under which prebaking and postbaking are performed. Wafers belonging to the same lot are usually heated under the same conditions.

Different processing recipes can include different heat treatment temperatures and different heat treatment times. Commonly, the heat treatment temperatures, and thus the hotplate temperatures, must be lowered or raised several times a day to accommodate the different processing recipes. Such frequent hotplate temperature changes can severely reduce wafer throughput of the processing systems due to system idle time during lowering or raising of the hotplate temperature. In particular, lowering of the hotplate temperate results in long idle times due to normally slow lowering of the hotplate temperature. Therefore, new methods are needed that provide the rapid cool down of the hotplate required for high wafer throughput.

### SUMMARY OF THE INVENTION

Embodiments of the invention provide a method and processing system for controlling and rapidly adjusting the temperature of a hotplate used for supporting and heating-treating wafers. Embodiments of the invention may be applied to heat-treating of resist-coated wafers at different hotplate temperatures with high wafer throughput.

According to one embodiment, the method includes maintaining the hotplate at a first hotplate temperature by applying a first heating power to the hotplate and heat-treating a wafer on an upper surface of the hotplate, removing the heat-treated wafer from the upper surface, exposing the upper surface to an inert gas stream for rapid cool down of the hotplate from the first hotplate temperature to a second hotplate temperature, and maintaining the hotplate at the second hotplate temperature by applying a second heating power to the hotplate and heat-treating another wafer on the upper surface of the hotplate.

According to another embodiment of the invention, a processing system is provided. The processing system includes a hotplate containing an upper surface configured for supporting and heat-treating a wafer, a gas injection system configured for exposing the upper surface of the hotplate to an inert gas stream for rapid cool down of the hotplate from a first hotplate temperature to a second hotplate temperature, a heater configured for heating the hotplate, and a controller configured for monitoring the temperature of the hotplate, and controlling the gas injection system and the heater in response to the monitored temperature.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a top view of a schematic diagram of a coating/developing system for use in accordance with embodiments of the invention;

FIG. 2 is a front view of the coating/developing system of FIG. 1;

FIG. 3 is a partially cut-away back view of the coating/developing system of FIG. 1, as taken along line 3-3;

FIG. 4 is a cross-sectional view of a single heat treatment processing system of FIG. 3;

FIG. 5a is a plan view of the heat treatment processing system of FIG. 4, as viewed from line 5-5;

FIG. 5b is a plan view of the heat treatment processing system of FIG. 4, as viewed from line 5-5;

FIG. 6 is a diagrammatic view of a hotplate of a heat treatment processing system in accordance with an embodiment of the invention;

FIGS. 7A and 7B are diagrammatic views of hotplates in accordance with embodiments of the invention;

FIG. 8 is a diagrammatic view of a hotplate in accordance with an alternative embodiment of the invention;

FIG. 9 is a simplified process flow diagram for a method of patterning a resist coated wafer according to an embodiment of the invention; and

FIG. 10 is a simplified process flow diagram of a method for controlling and rapidly lowering the temperature of a hotplate used for supporting and heat-treating wafers in accordance with an embodiment of the invention.

### DETAILED DESCRIPTION OF SEVERAL EMBODIMENTS

Embodiments of the invention provide a method and processing system for controlling and rapidly lowering the temperature of a hotplate used for supporting and heating-treating wafers. Embodiments of the invention may be applied to heat-treating of resist-coated wafers with high wafer throughput. The terms “wafer” and “substrate” are used interchangeably herein to refer to a thin slice of material, such as a silicon crystal or glass material, upon which microcircuits are constructed, for example by diffusion, deposition, and etching of various materials.

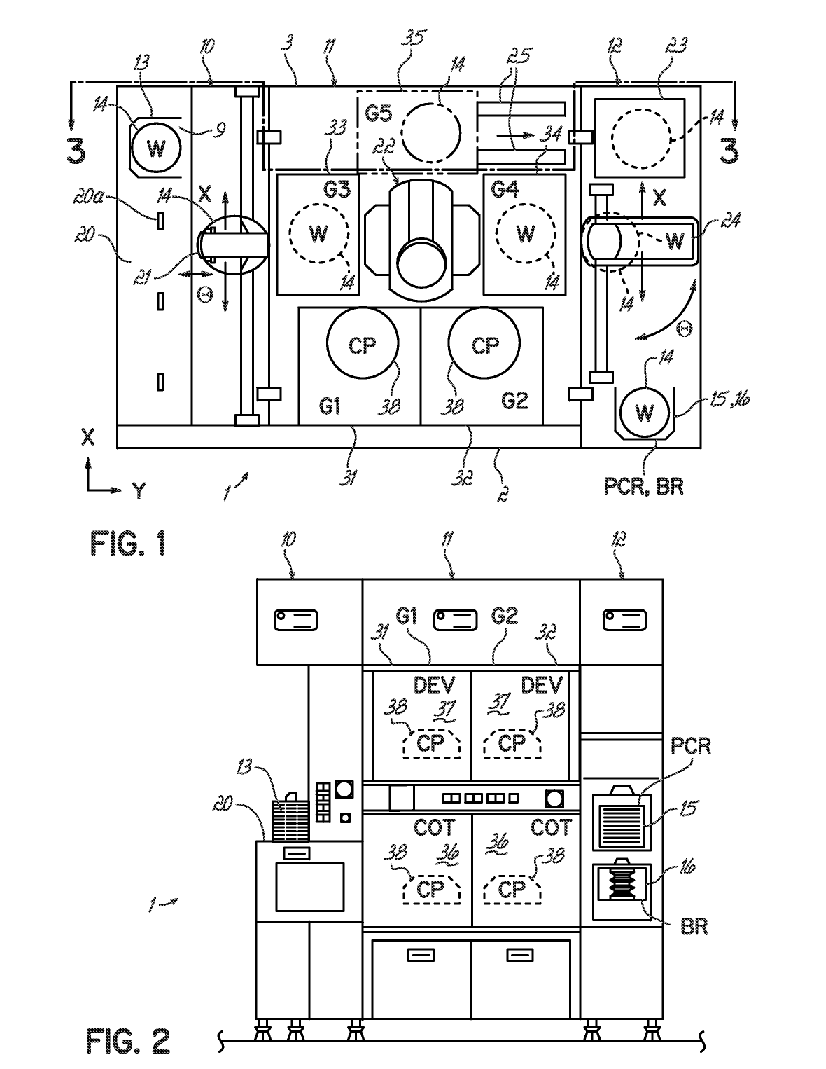

With reference to FIGS. 1-3, a coating/developing processing system 1 has a load/unload section 10, a process section 11, and an interface section 12. The load/unload section 10 has a cassette table 20 on which cassettes (CR) 13, each storing a plurality of semiconductor wafers (W) 14 (e.g., 25), are loaded and unloaded from the processing system 1. The process section 11 has various single wafer processing units for processing wafers 14 sequentially one by one. These processing units are arranged in predetermined positions of multiple stages, for example, within first (G1), second (G2), third (G3), fourth (G4) and fifth (G5) multiple-stage process unit groups 31, 32, 33, 34, 35. The interface section 12 is interposed between the process section 11 and one or more light exposure systems (not shown), and is configured to transfer resist coated wafers between the process section. The one or more light exposure systems can include a resist patterning system such as a photolithography tool that transfers the image of a circuit or a component from a mask or onto a resist on the wafer surface.

The coating/developing processing system 1 also includes a CD metrology system for obtaining CD metrology data from test areas on the patterned wafers. The CD metrology system may be located within the processing system 1, for example at one of the multiple-stage process unit groups 31, 32, 33, 34, 35. The CD metrology system can be a light scattering system such as an optical digital profilometry (ODP) system.

The ODP system may include a scatterometer, incorporating beam profile ellipsometry (ellipsometer) and beam profile reflectometry (reflectometer), commercially available from Therma-Wave, Inc. (1250 Reliance Way, Fremont, Calif. 94539) or Nanometrics, Inc. (1550 Buckeye Drive, Milpitas, Calif. 95035). ODP software is available from Timbre Technologies Inc. (2953 Bunker Hill Lane, Santa Clara, Calif. 95054).

When performing optical metrology, such as scatterometry, a structure on a substrate, such as a semiconductor wafer or flat panel, is illuminated with electromagnetic (EM) radiation, and a diffracted signal received from the structure is utilized to reconstruct the profile of the structure. The structure may include a periodic structure, or a non-periodic structure. Additionally, the structure may include an operating structure on the substrate (i.e., a via or contact hole, or an interconnect line or trench, or a feature formed in a mask layer associated therewith), or the structure may include a periodic grating or non-periodic grating formed proximate to an operating structure formed on a substrate. For example, the periodic grating can be formed adjacent a transistor formed on the substrate. Alternatively, the periodic grating can be formed in an area of the transistor that does not interfere with the operation of the transistor. The profile of the periodic grating is obtained to determine whether the periodic grating, and by extension the operating structure adjacent the periodic grating, has been fabricated according to specifications.

Still referring to FIGS. 1-3, a plurality of projections 20a are formed on the cassette table 20. A plurality of cassettes 13 are each oriented relative to the process section 11 by these projections 20a. Each of the cassettes 13 mounted on the cassette table 20 has a load/unload opening 9 facing the process section 11.

The load/unload section 10 includes a first sub-arm mechanism 21 that is responsible for loading/unloading the wafer W into/from each cassette 13. The first sub-arm mechanism 21 has a holder portion for holding the wafer 14, a back and forth moving mechanism (not shown) for moving the holder portion back and forth, an X-axis moving mechanism (not shown) for moving the holder portion in an X-axis direction, a Z-axis moving mechanism (not shown) for moving the holder portion in a Z-axis direction, and a θ (theta) rotation mechanism (not shown) for rotating the holder portion around the Z-axis. The first sub-arm mechanism 21 can gain access to an alignment unit (ALIM) 41 and an extension unit (EXT) 42 belonging to a third (G3) process unit group 33, as further described below.

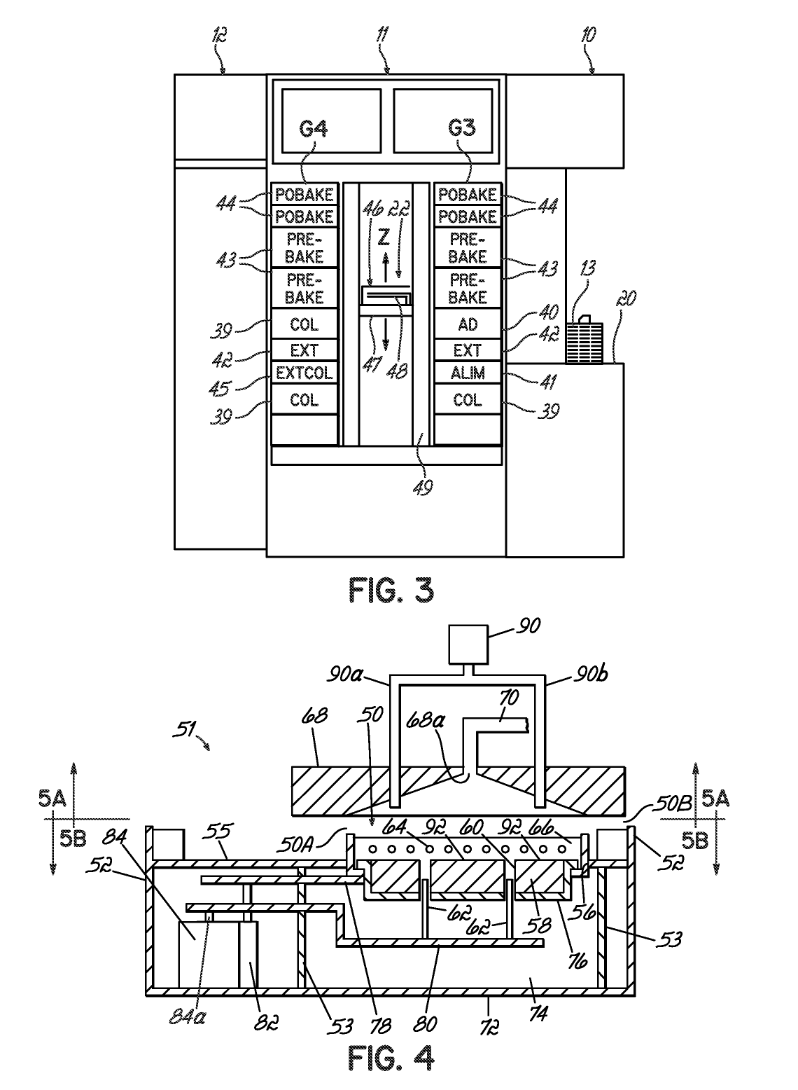

With specific reference to FIG. 3, a main arm mechanism 22 is liftably arranged at the center of the process section 11. The process units G1-G5 are arranged around the main arm mechanism 22. The main arm mechanism 22 is arranged within a cylindrical supporting body 49 and has a liftable wafer transporting system 46. The cylindrical supporting body 49 is connected to a driving shaft of a motor (not shown). The driving shaft may be rotated about the Z-axis in synchronism with the wafer transporting system 46 by an angle of θ. The wafer transporting system 46 has a plurality of holder portions 48 movable in a front and rear direction of a transfer base table 47.

Units belonging to first (G1) and second (G2) process unit groups 31, 32, are arranged at the front portion 2 of the coating/developing processing system 1. Units belonging to the third (G3) process unit group 33 are arranged next to the load/unload section 10. Units belonging to a fourth (G4) process unit group 34 are arranged next to the interface section 12. Units belonging to a fifth (G5) process unit group 35 are arranged in a back portion 3 of the processing system 1.

With reference to FIG. 2, the first (G1) process unit group 31 has two spinner-type process units for applying a predetermined treatment to the wafer 14 mounted on a spin chuck (not shown) within the cup (CP) 38. In the first (G1) process unit group 31, for example, a resist coating unit (COT) 36 and a developing unit (DEV) 37 are stacked in two stages sequentially from the bottom. In the second (G2) process unit group 32, two spinner type process units such as a resist coating unit (COT) 36 and a developing unit (DEV) 37, are stacked in two stages sequentially from the bottom. In an exemplary embodiment, the resist coating unit (COT) 36 is set at a lower stage than the developing unit (DEV) 37 because a discharge line (not shown) for the resist waste solution is desired to be shorter than a developing waste solution for the reason that the resist waste solution is more difficult to discharge than the developing waste solution. However, if necessary, the resist coating unit (COT) 36 may be arranged at an upper stage relative to the developing unit (DEV) 37.

With reference to FIG. 3, the third (G3) process unit group 33 has a cooling unit (COL) 39, an alignment unit (ALIM) 41, an adhesion unit (AD) 40, an extension unit (EXT) 42, two prebaking units (PREBAKE) 43, and two postbaking units (POBAKE) 44, which are stacked sequentially from the bottom.

Similarly, the fourth (G4) process unit group 34 has a cooling unit (COL) 39, an extension-cooling unit (EXTCOL) 45, an extension unit (EXT) 42, another cooling unit (COL) 39, two prebaking units (PREBAKE) 43 and two postbaking units (POBAKE) 44 stacked sequentially from the bottom. Although, only two prebaking units 43 and only two postbaking units 44 are shown, G3 and G4 may contain any number of prebaking units 43 and postbaking units 44. Furthermore, any or all of the prebaking units 43 and postbaking units 44 may be configured to perform PEB, post application bake (PAB), and post developing bake (PDB) processes.

In an exemplary embodiment, the cooling unit (COL) 39 and the extension cooling unit (EXTCOL) 45, to be operated at low processing temperatures, are arranged at lower stages, and the prebaking unit (PREBAKE) 43, the postbaking unit (POBAKE) 44 and the adhesion unit (AD) 40, to be operated at high temperatures, are arranged at the upper stages. With this arrangement, thermal interference between units may be reduced. Alternatively, these units may have different arrangements.

At the front side of the interface section 12, a movable pick-up cassette (PCR) 15 and a non-movable buffer cassette (BR) 16 are arranged in two stages. At the backside of the interface section 12, a peripheral light exposure system 23 is arranged. The peripheral light exposure system 23 can contain a lithography tool. Alternately, the lithography tool and the ODP system may be remote to and cooperatively coupled to the coating/developing processing system 1. At the center portion of the interface section 12, a second sub-arm mechanism 24 is provided, which is movable independently in the X and Z directions, and which is capable of gaining access to both cassettes (PCR) 15 and (BR) 16 and the peripheral light exposure system 23. In addition, the second sub-arm mechanism 24 is rotatable around the Z-axis by an angle of θ and is designed to be able to gain access not only to the extension unit (EXT) 42 located in the fourth (G4) processing unit 34 but also to a wafer transfer table (not shown) near a remote light exposure system (not shown).

In the processing system 1, the fifth (G5) processing unit group 35 may be arranged at the back portion 3 of the backside of the main arm mechanism 22. The fifth (G5) processing unit group 35 may be slidably shifted in the Y-axis direction along a guide rail 25. Since the fifth (G5) processing unit group 35 may be shifted as mentioned, maintenance operation may be applied to the main arm mechanism 22 easily from the backside.

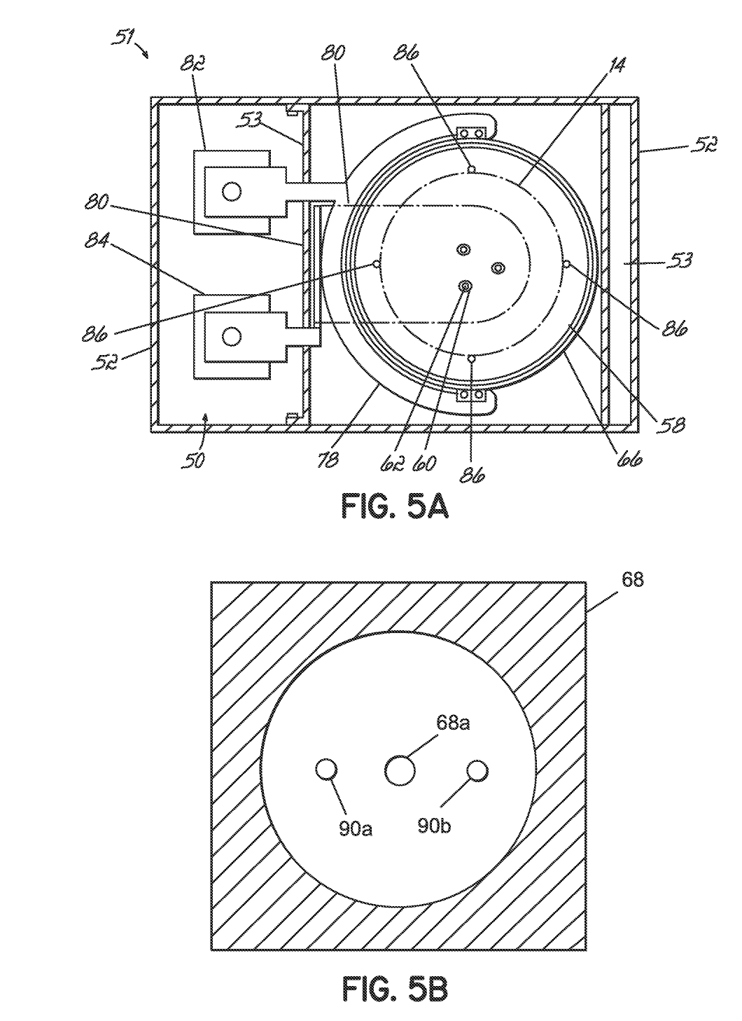

The prebaking unit (PREBAKE) 43, the postbaking unit (POBAKE) 44, and the adhesion unit (AD) 40 each comprise a heat treatment system in which wafers 14 are heated to temperatures above room temperature. With reference to FIGS. 4 and 5A-5B, each heat treatment system 51 includes a processing chamber 50, a hotplate 58, and a resistance heater (not shown) embedded in the hotplate 58.

The hotplate 58 has a plurality of through-holes 60 and a plurality of lift pins 62 inserted into the through-holes 60. The lift pins 62 are connected to and supported by an arm 80, which is further connected to and supported by a rod 84a of a liftable vertical cylinder 84. When the rod 84a is actuated to protrude from the vertical cylinder 84, the lift pins 62 protrude from the hotplate 58, thereby lifting the wafer 14 from the upper surface 92 of the hotplate 58.

With continued reference to FIGS. 4 and 5A-5B, the processing chamber 50 is defined by a sidewall 52, a horizontal shielding plate 55, and a cover 68. Openings 50A, 50B are formed at a front surface side (aisle side of the main arm mechanism 22) and a rear surface side of the processing chamber 50, respectively. The wafer 14 is loaded into and unloaded from the processing chamber 50 through the openings 50A, 50B. A circular opening 56 is formed at the center of the horizontal shielding plate 55. The hotplate 58 is housed in the opening 56. The hotplate 58 is supported by the horizontal shielding plate 55 with the aid of a supporting plate 76.

A ring-form shutter 66 is attached to the outer periphery of the hotplate 58. Air holes 64 are formed along the periphery of the shutter 66 at intervals of central angles of two degrees. The air holes 64 communicate with a cooling gas supply source (not shown).

The shutter 66 is liftably supported by a cylinder 82 via a shutter arm 78. The shutter 66 is positioned at a place lower than the hotplate 58 at a non-operation time (i.e., when a wafer is not present on the upper hotplate surface 92), whereas, at an operation time (i.e., when a wafer is being heat-treated on the upper hotplate surface 92), shutter 66 is lifted up to a position higher than the hotplate 58 and between the hotplate 58 and the cover 68. When the shutter 66 is lifted up, at an operation time, an gas, such as nitrogen gas or air, is exhausted from the air holes 64.

Gas generated from the surface of the wafer 14 at the heat treatment detected temperature time is exhausted through the exhaust port 68a and vented from the processing chamber 50 via exhaust pipe 70 to an evacuation unit (not shown).

With reference to FIGS. 4 and 5A-5B, a compartment 74 is defined by the horizontal shielding plate 55, two sidewalls 53, and a bottom plate 72 formed below the horizontal shielding plate 55. Hotplate supporting plate 76, shutter arm 78, lift pin arm 80, and liftable cylinders 82, 84 are arranged in the compartment 74.

With reference to FIG. 5A, a plurality of projections 86 are formed on an upper surface of the hotplate 58 for accurately positioning the wafer 14. In addition, a plurality of smaller projections (not shown) is formed on the upper surface of the hotplate 58. When the wafer 14 is mounted on the hotplate 58, top portions of these smaller projections contact the wafer 14, which produces a small gap between the wafer 14 and the hotplate 58 that prevents the lower surface of the wafer 14 from being strained and damaged.

With reference to FIGS. 4 and 5B, the heat treatment system 51 further includes a gas injection system 90 coupled to gas lines 90a and 90b that are configured for exposing the upper surface 92 of the hotplate 58 to an inert gas stream for rapidly cooling the upper surface 92 and the rest of the hotplate 58 when a wafer is not present on the upper surface 92. The inert gas can, for example, include argon (Ar) or nitrogen (N₂). Although two gas lines are depicted in FIGS. 4 and 5B, any number of gas lines may be used.

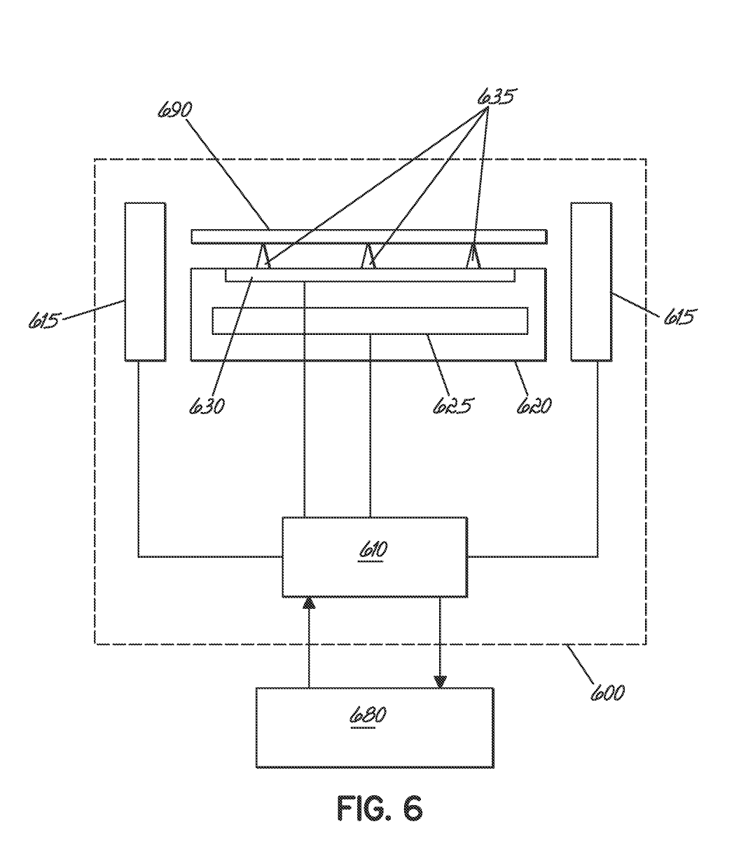

With reference to FIG. 6, a heat-treatment system 600 in accordance with an embodiment of the invention includes a controller 610, a ventilation system 615, and a hotplate 620. Hotplate 620 includes a heater 625, a sensor 630, and wafer support pins 635. A wafer 690 may be positioned on hotplate 620 using wafer support pins 635.

Hotplate 620 may have a circular shape and may comprise a number of segments (not shown). In addition, heater 625 may comprise a number of heating elements (not shown). For example, a heating element may be positioned within each segment of the hotplate 620. In an alternate embodiment, hotplate 620 may incorporate a cooling element and/or a combined heating/cooling element rather than a heating element.

Hotplate 620 may include a sensor 630, which may be a physical sensor and/or a virtual sensor. For example, sensor 630 may be a temperature sensor located within each hotplate segment. In addition, sensor 630 may include at least one pressure sensor. Controller 610 may be coupled to heater 625 and sensor 630. Various types of physical temperature sensors 630 may be used. For example, the sensors 630 can include a thermocouple, a temperature-indicating resistor, a radiation type temperature sensor, and the like. Other physical sensors 630 include contact-type sensors and non-contact sensors.

Heat-treatment system 600 may be coupled to a processing system controller 680 capable of providing data for an incoming wafer to heat-treatment system 600. The data can include wafer information, layer information, process information, and metrology information. Wafer information can include composition data, size data, thickness data, and temperature data. Layer information can include the number of layers, the composition of the layers, and the thickness of the layers. Process information can include data concerning previous steps and the current step. Metrology information can include optical digital profile data, such as critical dimension (CD) data, profile data, and uniformity data, and optical data, such as refractive index (n) data and extinction coefficient (k) data. For example, CD data and profile data can include information for features and open areas in one or more layers, and can also include uniformity data.

Controller 610 may control the temperature of each of the plurality of hotplate segments (temperature control zones) to establish a temperature profile for the hotplate surface. The controller 610 may receive instructions from a CD optimizer system to adjust the temperature of the plurality of hotplate segments based on CD metrology data received from heat-treated wafers. The CD optimizer system may be contained in the processing system controller 680 or the CD optimizer system may be contained in the controller 610. Adjusting the temperature of the plurality of hotplate segments establishes an adjusted temperature profile for the hotplate surface for heat-treating additional resist coated manufacturing wafers.

Controller 610 may comprise a microprocessor, a memory (e.g., volatile and/or non-volatile memory), and a digital I/O port. A program stored in the memory may be utilized to control the aforementioned components of a heat-treatment system according to a process recipe. Controller 610 may be configured to analyze the process data, to compare the process data with target process data, and to use the comparison to change a process and/or control the processing system components.

A ventilation system 615 is provided around the hotplate 620. Air or nitrogen gas may be provided to one or more surfaces of the hotplate 620 by ventilation system 615 during heat-treating of the wafer 690. For example, a shutter 66 and air holes 64 (FIG. 4) may be used. The ventilation system 615 can communicate with a gas supply source (not shown) at the upstream. Controller 610 can control the flow rate of gas flowing from the ventilation system 615. In an alternate embodiment, heat-treatment system 600 may include a monitoring device (not shown) that, for example, permits optical monitoring of the wafer.

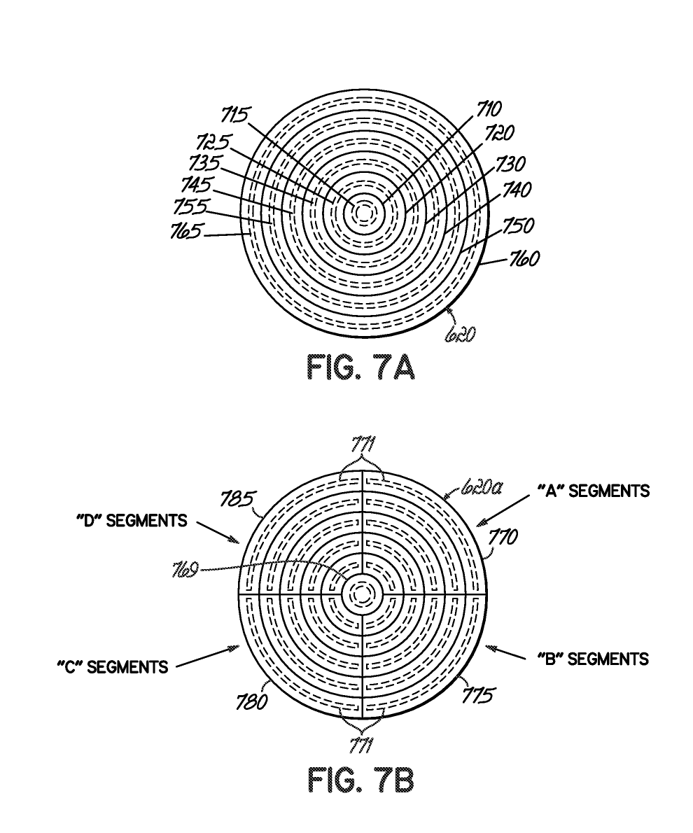

FIGS. 7A and 7B show exemplary schematic views of hotplates in accordance with an embodiment of the invention. In FIG. 7A, a circular hotplate 620 has a circular segment 710 and a plurality of annular ring segments 720, 730, 740, 750, and 760. Hotplate 620 may include any number of segments, which may have any suitable geometrical arrangement and/or dimensions. For example, the annular ring segments may have different radial dimensions relative to the hotplate centerline. In the illustrated embodiment, each segment 710, 720, 730, 740, 750, and 760 includes a corresponding one of a plurality of heating elements 715, 725, 735, 745, 755, and 765, each of which may be independently controlled.

With reference to FIG. 7B, a circular hotplate 620a has a circular central segment 769 and a plurality of sectors 770, 775, 780, 785. Equal radial dimension segments A, B, C, D are shown in FIG. 7B, but this is not required for the invention. Hotplate 620a may include any number of sectors and segments, which may have any suitable geometrical arrangement and/or dimensions. In the illustrated embodiment, individual segments A, B, C, and D in sectors 770, 775, 780, 785 and central segment 769 each include at least one of a plurality of heating elements 771 that may each be independently controlled.

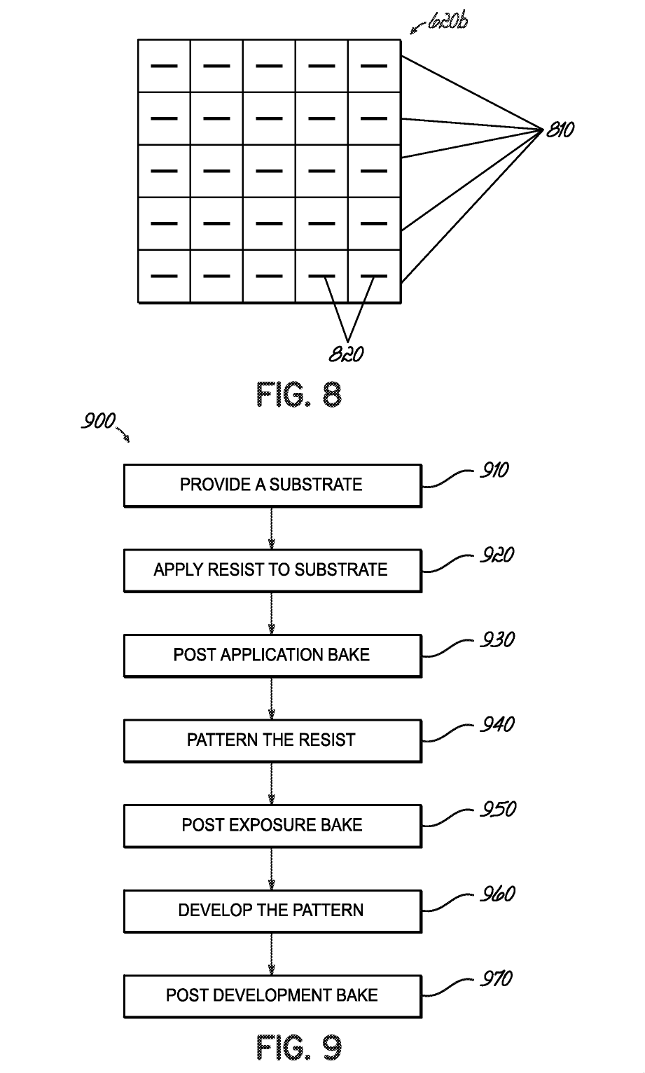

FIG. 8 shows a schematic view of another hotplate 620b, in accordance with an embodiment of the invention, having a plurality of, for example, twenty-five square segments 810. Hotplate 620b may comprise a different number of segments 810, and the segments 810 may be shaped differently. For example, rectangular shapes may be used. In the illustrated embodiment, each segment 810 of the hotplate 620b includes a heating element 820, and each heating element 820 may be independently controlled.

Alternately, any of hotplates 620 and 620a-b may be constructed in the jacket form having at least one hollow and at least one recess. The wafer 690 (FIG. 6) may be heated by circulating a heat medium to the recesses, such as by inserting a heater or a heat pipe (not shown) into one or more recesses containing a liquid (heat medium). Alternatively, the hotplate may be heated to a predetermined heat-treatment temperature by allowing at least one hollow to be filled with vapor generated from a heat medium by application of heat thereto at one or more of the recesses.

FIG. 9 is a simplified process flow diagram for a method of patterning a resist coated manufacturing wafer according to embodiments of the invention. The patterning process produces a pattern that covers portions of the wafer with a resist. For example, during a photolithography process, complex circuit patterns are imaged onto the photosensitive resist material by a lithography tool to provide a physical barrier during further processing of the wafer to form semiconductor devices. During the further processing, the lithographic pattern can be transferred into the underlying wafer or wafer layers by an etching process (e.g., a plasma etching process) that includes selective removal of wafer material not covered by resist.

The process 900 represents a typical process to which embodiments of the invention can be applied. Referring also to FIGS. 1-3, starting at 910, a wafer is provided in a processing system, for example the coating/developing processing system 1 depicted in FIGS. 1-3.

In 920, a resist is applied to the wafer. For example, the resist material can be applied by dispensing a liquid containing the resist material onto the wafer while the wafer is mounted on a spin chuck (not shown) with a cup (not shown). For example, the resist can be a chemically amplified resist (CAR). A CAR can be characterized by an acid component, a quenched component, and an inhibitor quencher. In one example, an adhesion layer or a surfactant layer can be provided on the wafer surface before the resist material is applied.

CARs were developed to enhance the exposure process because of the low spectral energy of deep ultraviolet (DUV) radiation. A CAR contains one or more components that are insoluble in a developer solution. These components can comprise chemical protectors. A CAR can also contain a photoacid generator (PAG). During a radiation exposure step, the PAGs produce acid molecules for the patterning process. Desirably, the acid molecules remain inactive until a post exposure bake (PEB) is performed. The PEB drives a deprotection reaction forward in which the thermal energy causes the acid to react with the chemical protectors.

In 930, a post application bake (PAB) can be performed in the coating/developing processing system 1 to cure the applied resist. In an alternate embodiment, a curing step is not required. In addition, a cooling step can be performed after the PAB. In a PAB heating unit, the resist can be heated to temperatures at least higher than room temperature, and in a cooling unit, the resist, can be cooled to temperatures at or below room temperature.

In 940, the resist is patterned in a lithography tool using light radiation or charged particles such as electrons. The desired pattern can, for example, be created on the resist using beams of high-energy electrons or arrays of laser beams and a mask that defines the size and shape of the pattern. For example, deep ultraviolet (DUV) can be used. DUV lithography is a key enabling technology that can be used to manufacture semiconductor devices with features of 0.25 microns (micron=10⁻⁶ m) or less.

In other cases, extreme ultraviolet (EUV) sources can be used for critical dimensions below 0.05 microns. EUV lithography utilizes light with wavelengths in a range of about 5 nm to 50 nm, with about 13 nm being the most common.

In 940, the resist pattern is exposed to the light radiation or charged particles for a predetermined time period to achieve a desired exposure dose. Exposure dose refers to the amount of energy (per unit area) that the resist is subjected to upon exposure by a lithography tool. For optical lithography, exposure dose is equal to the light intensity times the exposure time. In resist patterning, resolution is the smallest feature that can be printed (e.g., for a given process and processing system) with sufficient quality. It is common to use focus and exposure dose as process variables, so that resolution is defined as the smallest feature of a given type that can be printed with a specified depth of focus. The depth of focus of a feature is often defined as the range of focus that keeps the resist profile of a given feature within all specifications (e.g., linewidth, sidewall angle, resist loss) over a specified exposure range.

The lithography tool can contain a controller to control the exposure dose and focus across a wafer to be patterned. The controller may receive instructions from a CD optimizer system to adjust the exposure dose and focus based on CD metrology data received from the patterned wafers. Adjusting the exposure dose and focus of the lithography tool establishes adjusted exposure dose and focus settings across the wafer for patterning additional resist coated manufacturing wafers.

In 950, a PEB process can be performed in the coating/developing processing system 1 to drive the de-protection reaction forward. The de-protection reaction is acid driven and takes place in the areas exposed to the radiation or to the charged particles. In addition, a cooling step can be performed after the PEB. In a PEB process, the resist can be heated to temperatures at least higher that room temperature, and in a cooling unit, the resist, can be cooled to temperatures at or below room temperature.

The PEB process plays an important role in the process 900. Heat-treating a resist can have many purposes that range from removing a solvent from the resist material to catalyzing the chemical amplification. In addition to the intended results, heat-treating can cause numerous problems. For example, the light or charged particle sensitive component of the resist may decompose at temperatures typically used to remove the solvent, which is an extremely serious concern for a chemically amplified resist since the remaining solvent content has a strong impact on the diffusion and amplification rates. In addition, heat-treating can affect the dissolution properties of the resist and thus have direct influence on the developed resist profile. Many resists are particularly sensitive to temperature variations during a heat-treatment, such as PEB, and temperature variations can result in variations in CDs across a wafer surface and between different hotplates.

In 960, the resist is developed in the coating/developing processing system 1 by selectively dissolving exposed areas of the resist. For example, a developing solution, such as a 2.3 wt. % solution of tetramethyl ammonium hydroxide (TMAH), can be used. In addition, rinsing steps can also be performed. For example, a developing solution and/or a rinsing solution can be applied by mounting the wafer on a spin chuck (not shown) within a cup (not shown).

In 970, a post development bake (PDB) can be performed in the coating/developing processing system 1 to harden the resist pattern in preparation for subsequent pattern transfer into the underlying wafer or wafer layers. For example, the post development bake can improve the etch resistance of the patterned resist during plasma etching of the underlying wafer.

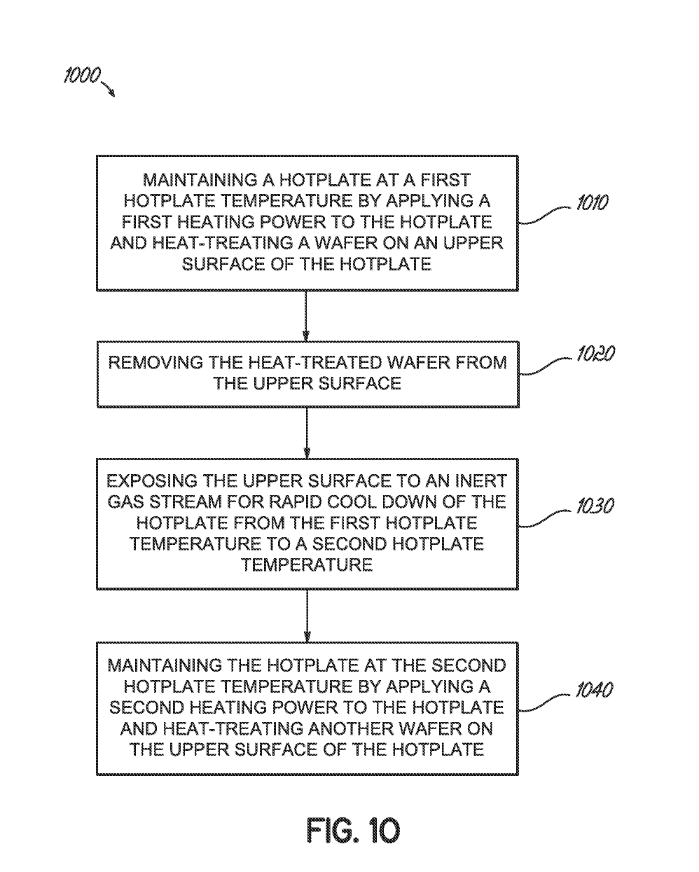

FIG. 10 is a simplified process flow diagram of a method for controlling and rapidly lowering the temperature of a hotplate used for supporting and heat-treating wafers in accordance with an embodiment of the invention. The process flow 1100 includes, in step 1110, maintaining a hotplate at a first hotplate temperature by applying a first heating power to the hotplate and heat-treating a wafer on an upper surface of the hotplate.

According to an embodiment of the invention, the wafer may be a resist coated wafer and the heat-treating can, for example, include a PEB process or a PDB process. The PEB process is a thermally activated process and serves multiple purposes in photoresist processing. First, the elevated temperature of the bake drives the diffusion of the photoproducts. A small amount of diffusion may be useful in minimizing the effects of standing waves, which are the periodic variations in exposure dose throughout the depth of the film that result from interference of incident and reflected radiation. The other main purpose of the PEB is to drive an acid-catalyzed reaction that alters polymer solubility in many chemically amplified resists.

The hotplate may be divided into a plurality of temperature zones and maintaining the hotplate at the first hotplate temperature can include establishing a first temperature profile for the upper surface of the hotplate. Substantially equal temperatures can be established for all of the temperature control zones. Alternately, different temperatures can be established for one or more of the temperature control zones. According to an embodiment of the invention, establishing the temperature profile can include establishing a known temperature for each of the plurality of temperature control zones. For example, a temperature profile can be established based on historical data for this type of wafer and resist. In one embodiment, one or more heater elements are located within each temperature control zone. In addition, one or more temperature sensors can be located within each temperature control zone. Alternately, optical techniques can be used to measure temperature.

In step 1020, the heat-treated first wafer is removed from the upper surface of the hotplate. The wafer may be the last wafer of a batch of wafers that is heat-treated at the first hotplate temperature.

Next, the temperature of the hotplate is lowered from the first hotplate temperature to a second hotplate temperature for heat-treating a new batch of wafers. Different processing recipes may require different heat-treating temperatures and different heat-treatment times. In order to maintain high wafer throughput, the hotplate temperature needs to be rapidly lowered from the first hotplate temperature to the second hotplate temperature.

In step 1030, the upper surface of the hotplate is exposed to an inert gas stream for rapid cool down of the hotplate from the first hotplate temperature to the second hotplate temperature. The inert gas exposure is performed without a wafer on the upper surface. The inert gas stream may be supplied from one or more gas lines positioned above the upper surface of the hotplate. The number of gas lines and the total inert gas flow rate may be selected based on the desired cool down rate for the hotplate. According to an embodiment of the invention, the temperature of the hotplate may be monitored during the exposure of the inert gas stream. The monitoring may include detecting changes in the hotplate temperature from the first hotplate temperature and comparing the changes to the second hotplate temperature. When the second hotplate temperature has been reached, the exposing can be stopped.

In step 1040, the hotplate is maintained at the second hotplate temperature by applying a second heating power to the hotplate and heat-treating another wafer on the upper surface of the hotplate. Maintaining the hotplate at the second hotplate temperature can include establishing a second temperature profile for the hotplate surface. According to an embodiment of the invention, establishing the second temperature profile can include establishing a second known temperature for each of the plurality of temperature control zones. In one example, CD metrology data from processed wafers may be forwarded to a CD optimizer system and the temperature profile adjusted based on an output of the CD optimizer.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative system and methods, and illustrative examples shown and described. Accordingly, departures may be made from such details without departing from the scope of applicants' general inventive concept.

What is claimed is:

1. A method of controlling and rapidly adjusting the temperature of a hotplate used for supporting and heating wafers, the method comprising:
maintaining the hotplate at a first hotplate temperature by applying a first heating power to the hotplate and heat-treating a wafer on an upper surface of the hotplate;
removing the heat-treated wafer from the upper surface;
exposing the upper surface to an inert gas stream for rapid cool down of the hotplate from the first hotplate temperature to a second hotplate temperature; and
maintaining the hotplate at the second hotplate temperature by applying a second heating power to the hotplate and heat-treating another wafer on the upper surface of the hotplate.

2. The method of claim 1, wherein the inert gas stream is supplied from one or more gas lines positioned above the upper surface of the hotplate.

3. The method of claim 1, wherein the first and second heating powers are applied to a resistive heater or a lamp heater.

4. The method of claim 1, further comprising:
monitoring the temperature of the hotplate during the exposing.

5. The method of claim 4, wherein the monitoring comprises:
detecting changes in the hotplate temperature from the first hotplate temperature; and
comparing the changes to the second hotplate temperature.

6. The method of claim 5, further comprising:
stopping the exposing when the second hotplate temperature has been reached.

7. The method of claim 1, wherein the hotplate is divided into a plurality of temperature control zones and the maintaining the hotplate at a first hotplate temperature comprises establishing a first temperature profile for the upper surface of the hotplate and the maintaining the hotplate at the second hotplate temperature comprises establishing a second temperature profile for the upper surface of the hotplate.

8. The method of claim 7, wherein the establishing the first and second temperature profiles comprises:
establishing known temperatures for each of the plurality of temperature control zones.

9. The method of claim 1, wherein the heat-treating comprises a post exposure bake (PEB) or a post development bake (PDB).

10. A computer readable medium containing program instructions for execution on a processor, which when executed by the processor, cause a processing system to perform the steps of claim 1.

11. A processing system for heat-treating wafers, comprising:
a hotplate comprising an upper surface configured for supporting and heat-treating a wafer;
a gas injection system configured for exposing the upper surface of the hotplate to an inert gas stream for rapid cool down of the hotplate from a first hotplate temperature to a second hotplate temperature;
a heater configured for heating the hotplate; and
a controller configured for monitoring the temperature of the hotplate, and controlling the gas injection system and the heater in response to the monitored temperature of the hotplate.

12. The processing system of claim 11, wherein the gas injection system comprises one or more gas lines positioned above the upper surface of the hotplate for supplying the inert gas stream.

13. The processing system of claim 11, wherein the heater comprises a resistive heater or a lamp heater.

14. The processing system of claim 11, wherein the hotplate is divided into a plurality of temperature control zones.

15. The processing system of claim 11, wherein the controller is configured for detecting changes in the temperature of the hotplate and comparing the temperature to the second hotplate temperature.

16. The processing system of claim 11, wherein the controller is configured for stopping the exposing after the second hotplate temperature has been reached.
